(19) United States
(12) Patent Application Publication
(10) Pub. No.: US 2026/0324733 A1
(43) Pub. Date: Oct. 22, 2026

(54) HEATER ASSEMBLY AND AEROSOL-GENERATING DEVICE INCLUDING THE SAME

(71) Applicant: KT&G CORPORATION, Daejeon (KR)

(72) Inventors: Sang Kyu PARK, Gangdong-gu (KR); Hyun Ho AHN, Seoul (KR); Jun Yeop OH, Dongdaemun-gu (KR); Won Kyeong LEE, Gyeonggi-do (KR); Jong Seong JEONG, Sejong (KR)

(73) Assignee: KT&G CORPORATION, Daejeon (KR)

(21) Appl. No.: 19/119,383

(22) PCT Filed: Aug. 29, 2024
(86) PCT No.: PCT/KR2024/096092

§ 371 Date: Apr. 8, 2025

(30) Foreign Application Priority Data
Sep. 6, 2023 (KR) 10-2023-0118555

(51) Int. Cl. A24F 40/465; A24F 40/48; H05B 6/80

(52) U.S. Cl. CPC A24F 40/465; A24F 40/48; H05B 6/804

(57) ABSTRACT

A heater assembly according to an embodiment includes an oscillator that generates microwaves in a designated frequency band, and a resonator that receives the generated microwaves from the oscillator through a coupler and generates an electric field by resonating the received microwaves, wherein the resonator may include an outer conductor including a first surface, a second surface facing the first surface, and a side surface surrounding an internal space between the first surface and the second surface, and including a housing space for accommodating an aerosol-generating article, a first internal conductor extending from the first surface toward the internal space and surrounding one region of the aerosol-generating article accommodated in the housing space, a first airflow passage connecting an exterior of the resonator to the housing space, and a second airflow passage connecting the exterior of the resonator to an interior of the resonator.

### TECHNICAL FIELD

Embodiments relate to a heater assembly capable of generating an aerosol by heating an aerosol-generating article through dielectric heating, and an aerosol-generating device including the same.

### BACKGROUND ART

Recently, there has been an increasing demand for alternative methods that reduce disadvantages of general cigarettes. For example, there has been an increasing demand for a device (or an “aerosol generating device”) that generates an aerosol by heating an aerosol generating material (or an “aerosol generating article”) by using the aerosol generating device, instead of a method of generating an aerosol by burning a cigarette.

Recently, interest in a dielectric heating-type aerosol-generating device, which generates an aerosol by heating an aerosol-generating article including a dielectric material by using microwave resonance, has been increased.

### DISCLOSURE OF INVENTION

### Technical Problem

As a dielectric heating-type aerosol-generating device uses high-frequency microwave resonance, a heat generation phenomenon may occur in a heater assembly that dielectrically heats an aerosol-generating article.

Due to the heat generation phenomenon, elements inside the aerosol-generating device may break down or malfunction, and users who use the aerosol-generating device may suffer from burns on their hands.

Problems to be solved by embodiments of the present disclosure are not limited to the problems described above, and problems not described above may be clearly understood by a person having ordinary skill in the art to which the embodiments belong from the present specification and the attached drawings.

### Solution to Problem

A heater assembly and an aerosol-generating device including the same, according to the present disclosure, are intended to solve the above-described problems of the related art, and a dielectric heating-type aerosol-generating device that has a long lifespan and guarantees safety is provided to a user.

A heater assembly according to an embodiment includes an oscillator that generates microwaves in a designated frequency band, and a resonator that receives the generated microwaves from the oscillator through a coupler and generates an electric field by resonating the received microwaves, wherein the resonator may include an outer conductor including a first surface, a second surface facing the first surface, and a side surface surrounding an internal space between the first surface and the second surface, and including a housing space for accommodating an aerosol-generating article, a first internal conductor extending from the first surface toward the internal space and surrounding one region of the aerosol-generating article accommodated in the housing space, a first airflow passage connecting an exterior of the resonator to the housing space, and a second airflow passage connecting the exterior of the resonator to an interior of the resonator.

An aerosol-generating device according to an embodiment includes a housing including an insertion hole into which an aerosol-generating article is inserted, and a heater assembly for heating the aerosol-generating article inserted through the insertion hole, wherein the heater assembly includes an oscillator that generates microwaves in a designated frequency band, and a resonator that receives the generated microwaves from the oscillator through a coupler and generates an electric field by resonating the received microwaves, and the resonator may include an outer conductor including a first surface, a second surface facing the first surface, and a side surface surrounding an internal space between the first surface and the second surface, and including a housing space for accommodating the aerosol-generating article, a first internal conductor extending from the first surface toward the internal space and surrounding one region of the aerosol-generating article accommodated in the housing space, a first airflow passage connecting an exterior of the resonator to the housing space, and a second airflow passage connecting the exterior of the resonator to an interior of the resonator.

According to an embodiment, an aerosol generating device includes a housing including an insertion hole into which an aerosol generating article is inserted and the heater assembly for heating the aerosol generating article inserted through the insertion hole.

### Advantageous Effects of Invention

A heater assembly and an aerosol-generating device including the same, according to various embodiments of the present disclosure, may emit heat generated from the heater assembly to the outside of the aerosol-generating device, thereby preventing a malfunction of the aerosol-generating device and ensuring safety of users of the aerosol-generating device.

### BRIEF DESCRIPTION OF DRAWINGS

FIG. 1 is a perspective view of an aerosol generating device according to an embodiment.

FIG. 2 is an internal block diagram of an aerosol generating device according to an embodiment.

FIG. 3 is an internal block diagram of a dielectric heating unit of FIG. 2.

FIG. 4 is a perspective view of a heater assembly according to an embodiment.

FIG. 5 is a cross-sectional view of the heater assembly of FIG. 4.

FIG. 6 is a perspective view of a heater assembly according to another embodiment.

FIG. 7 is a perspective view of a heater assembly according to another embodiment.

FIG. 8 is a cross-sectional view of an example of the heater assembly of FIG. 7.

FIG. 9 is a cross-sectional view of another example of the heater assembly of FIG. 7.

FIG. 10A is a diagram illustrating an example of an air inlet passage of the heater assembly of FIG. 7.

FIG. 10B is a diagram illustrating another example of the air inlet passage of the heater assembly of FIG. 7.

### BEST MODE FOR CARRYING OUT THE INVENTION

A heater assembly according to an embodiment includes an oscillator that generates microwaves in a designated frequency band, and a resonator that receives the generated microwaves from the oscillator through a coupler and generates an electric field by resonating the received microwaves, wherein the resonator includes an outer conductor including a first surface, a second surface facing the first surface, and a side surface surrounding an internal space between the first surface and the second surface, and including a housing space for accommodating an aerosol-generating article, a first internal conductor extending from the first surface toward the internal space and surrounding one region of the aerosol-generating article accommodated in the housing space, a first airflow passage connecting an exterior of the resonator to the housing space, and a second airflow passage connecting the exterior of the resonator to an interior of the resonator. The first airflow passage is arranged such that external air moves in a longitudinal direction of the housing space and then flows into one end of the aerosol-generating article inserted into the housing space.

The second airflow passage is arranged such that external air moves into the first internal conductor and then flows into one end of the aerosol-generating article inserted into the housing space.

The second airflow passage is arranged such that external air flows between the outer conductor and the first internal conductor.

The second airflow passage is arranged such that external air flows between the outer conductor and the first internal conductor, moves into the first internal conductor, and then flows into one end of the aerosol-generating article inserted into the housing space.

The resonator further includes a dielectric material housing space formed between the outer conductor and the first internal conductor, and a dielectric material arranged in the dielectric material housing space, and the second airflow passage is arranged such that external air moves into the dielectric material housing space and then flows into one end of the aerosol-generating article accommodated in the housing space.

The dielectric material includes an air inlet passage that passes through the dielectric material and is connected to the second airflow passage, and the external air moves along the air inlet passage and flows into the resonator.

The air inlet passage is formed to have a shape that is bent a plurality of times in a direction parallel or perpendicular to, or at an angle to a longitudinal direction of the dielectric material housing space.

The resonator further includes a heat dissipation member that is arranged inside the first internal conductor and absorbs heat inside the resonator.

The resonator further includes a second internal conductor extending from the second surface toward the internal space and surrounding another region of the accommodated aerosol-generating article.

The first internal conductor is arranged to surround the one region of the aerosol-generating article inserted into the housing space, the second internal conductor is spaced apart from the first internal conductor by a certain distance in the internal space and arranged to surround the other region of the aerosol-generating article accommodated in the housing space, and the resonator further includes a closure that is arranged inside the first internal conductor and closes a cross-section of the first internal conductor.

The closure includes an air inlet hole that passes through the closure and is connected to the first airflow passage or the second airflow passage, and external air that moves along the first airflow passage or the second airflow passage flows into one end of the aerosol-generating article through the air inlet hole.

An aerosol-generating device according to an embodiment includes a housing including an insertion hole into which an aerosol-generating article is inserted, and a heater assembly for heating the aerosol-generating article inserted through the insertion hole, wherein the heater assembly includes an oscillator that generates microwaves in a designated frequency band, and a resonator that receives the generated microwaves from the oscillator through a coupler and generates an electric field by resonating the received microwaves, and the resonator includes an outer conductor including a first surface, a second surface facing the first surface, and a side surface surrounding an internal space between the first surface and the second surface, and including a housing space for accommodating the aerosol-generating article, a first internal conductor extending from the first surface toward the internal space and surrounding one region of the aerosol-generating article accommodated in the housing space, a first airflow passage connecting an exterior of the resonator to the housing space, and a second airflow passage connecting the exterior of the resonator to an interior of the resonator.

The second airflow passage is arranged such that external air moves into the first internal conductor and then flows into one end of the aerosol-generating article inserted into the housing space.

The resonator further includes a second internal conductor extending from the second surface toward the internal space and surrounding another region of the accommodated aerosol-generating article.

### Mode for the Invention

Hereinafter, embodiments disclosed in this specification will be described in detail with reference to the accompanying drawings, and identical or similar components will be assigned the same reference numbers, regardless of the drawing symbols, and redundant explanations will be omitted.

The suffixes “module” and “unit” used in this description are assigned or used interchangeably solely for the convenience of drafting the specification and do not themselves have distinct meanings or roles.

Also, in describing the embodiments disclosed in this specification, detailed descriptions of well-known technologies may be omitted if it is determined that they could obscure the essence of the embodiments disclosed herein. Additionally, the accompanying drawings are provided merely to facilitate the understanding of the embodiments disclosed in this specification, and the technical spirit disclosed herein is not limited by the drawings. It should be understood that all modifications, equivalents, and substitutes that fall within the spirit and scope of this disclosure are included.

Terms including ordinal numbers, such as first, second, etc., may be used to describe various components, but the components are not limited by the terms. The above terms are used solely to distinguish one component from another.

When a component is referred to as being “connected” or “coupled” to another component, it should be understood that the component may be directly connected or coupled to the other component, or there may be intervening components in between. On the other hand, when a component is referred to as being “directly connected” or “directly coupled” to another component, it should be understood that there are no intervening components in between.

Singular expressions include plural expressions unless the context clearly indicates otherwise.

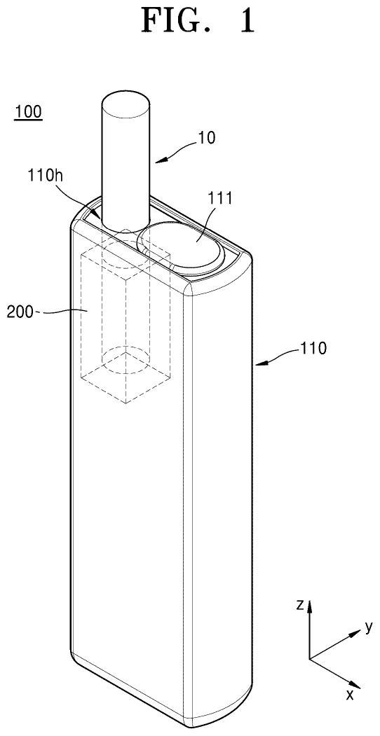

FIG. 1 is a perspective view of an aerosol generating device according to an embodiment. Referring to FIG. 1, an aerosol generating device 100 according to an embodiment may include a housing 110 including an accommodation space 110h for accommodating an aerosol generating article 10, a heater assembly 200 for heating the aerosol generating article 10 accommodated in the housing 110, a sensor 150 for detecting insertion of metal into the accommodating space 110h and a processor 130.

The housing 110 may form the overall exterior of the aerosol generating device 100, and components of the aerosol generating device 100 may be arranged in an inner space (or a ‘mounting space’) of the housing 110. For example, the heater assembly 200, a battery, a processor, and/or a sensor may be arranged in the inner space of the housing 110, but the components arranged in the inner space are not limited thereto.

The housing 110 may include an accommodation space 110h for accommodating an aerosol generating article 10, and at least one area of the aerosol generating article 10 may be inserted or received within the accommodation space 110h. For example, the accommodation space 110h may be formed in a portion of an upper surface (e.g., a surface in a z direction) of the housing 110, but the position of the accommodation space 110h is not limited thereto. In another embodiment, the accommodation space 110h may be formed in a portion of a side surface (e.g., a surface in an x direction) of the housing 110.

The heater assembly 200 may be arranged in the inner space of the housing 110 and heat the aerosol generating article 10 inserted into or accommodated in the housing 110 through the accommodation space 110h. For example, the heater assembly 200 may be positioned to surround at least a portion of the aerosol generating article 10 inserted into or accommodated in the accommodation space 110h, thus heating the aerosol generating article 10.

According to an embodiment, the heater assembly 200 may heat the aerosol generating article 10 by using a dielectric heating method. In the present specification, the term ‘dielectric heating method’ refers to a method of heating a dielectric material, which is a heating object, by using resonance of microwaves and/or an electric field (which may include a magnetic field) of the microwaves. Microwaves are energy sources used to heat a heating object and are generated by high-frequency power, and thus, the term ‘microwave’ may hereinafter be used interchangeably with microwave power.

Charges or ions in a dielectric material included in the aerosol generating article 10 may vibrate or rotate because of microwave resonance within the heater assembly 200, and frictional heat generated during the vibration or rotation of the charges or ions may cause heat to be generated from the dielectric material such that the aerosol generating article 10 may be heated.

As the aerosol generating article 10 is heated by the heater assembly 200, an aerosol may be generated from the aerosol generating article 10. In the present specification, the term ‘aerosol’ may refer to gaseous particles generated from a mixture of vapor and air that are produced as the aerosol generating article 10 is heated.

The aerosol generated from the aerosol generating article 10 may pass through the aerosol generating article 10 or may be discharged to the outside of the aerosol generating device 100 through an empty space between the aerosol generating article 10 and the accommodation space 110h. A user may place their mouth on a portion of the aerosol generating article 10 exposed to the outside of the housing 110 and may inhale the aerosol discharged from the aerosol generating device 100, thereby smoking.

According to one embodiment, an aerosol-generating device 100 may further include a cover 111 that is movably disposed in a housing 110 to open or close an insertion opening 110h. For example, the cover 111 may be slidably coupled to the upper surface of the housing 110, thereby exposing the insertion opening 110h to the outside of the aerosol-generating device 100 or covering the insertion opening 110h so that it is not exposed to the outside of the aerosol-generating device 100.

In one example, the cover 111 may be positioned at a first position or “open position” to expose the insertion opening 110h to the outside of the aerosol-generating device 100. When the aerosol-generating device 100 is exposed to the outside, an aerosol-generating article 10 may be inserted into the housing 110 through the insertion opening 110h.

In another example, the cover 111 may be positioned at a second position (or “closed position”) to cover the insertion opening 110h, preventing the insertion opening 110h from being exposed to the outside of the aerosol-generating device 100. At this time, when the aerosol-generating device 100 is not in use, the cover 111 may prevent external foreign substances from entering the interior of a heater assembly 200 through the insertion opening 110h.

Although FIG. 1 illustrates only an aerosol-generating device 100 for heating a solid-state aerosol-generating article 10, the aerosol-generating device 100 is not limited to the illustrated embodiment.

In another embodiment, an aerosol-generating device may generate an aerosol by heating an aerosol-generating substance in a liquid or gel state, instead of a solid-state aerosol-generating article 10, through the heater assembly 200.

In another embodiment, an aerosol-generating device may include both a heater assembly 200 for heating the aerosol-generating article 10 and a cartridge (or “vaporizer”) for heating an aerosol-generating substance in a liquid or gel state. The aerosol generated from the aerosol-generating substance may move along an airflow passage communicating between the cartridge and the aerosol-generating article 10, mix with the aerosol generated from the aerosol-generating article 10, and then pass through the aerosol-generating article 10 before being delivered to the user.

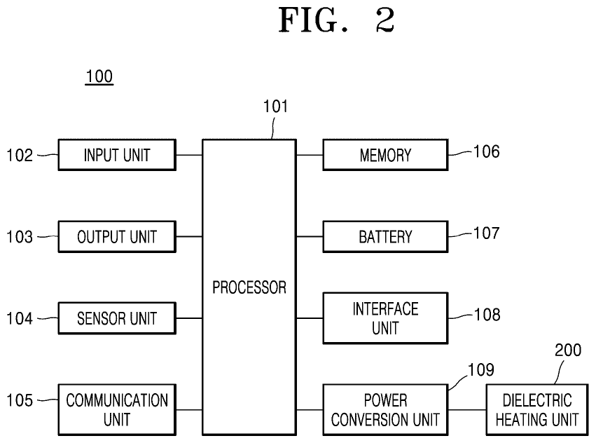

FIG. 2 is an internal block diagram of an aerosol generating device according to an embodiment.

Referring to FIG. 2, the aerosol generating device 100 may include an input unit 102, an output unit 103, a sensor unit 104, a communication unit 105, a memory 106, a battery 107, an interface unit 108, a power converter 109, and a dielectric heating unit 200. However, components of the aerosol generating device 100 are not limited to that illustrated in FIG. 2. Depending on design of the aerosol generating device 100, some of the components illustrated in FIG. 2 may be omitted or new component may be added.

The input unit 102 may receive a user input. For example, the input unit 102 may be a single pressure-type push button. As another example, the input unit 102 may be a touch panel including at least one touch sensor. The input unit 102 may transmit an input signal to a processor 101. The processor 101 may supply power to the dielectric heating unit 200 based on a user input or control the output unit 103 to output a user notification.

The output unit 103 may output information on a state of the aerosol generating device 100. The output unit 103 may output a charge/discharge state of the battery 107, a heating state of the dielectric heating unit 200, an insertion state of the aerosol generating article 10, and error information of the aerosol generating device 100. To this end, the output unit 103 may include a display, a haptic motor, and a sound output unit.

The sensor unit 104 may sense a state of the aerosol generating device 100 and a state around the aerosol generating device 100 and may transmit sensed information to the processor 101. Based on the sensed information, the processor 101 may control the aerosol generating device 100 to perform various functions, such as heating control of the dielectric heating unit 200, limiting smoking, determining whether the aerosol generating article 10 is inserted, and displaying a notification.

The sensor unit 104 may include a temperature sensor, a puff sensor, and an insertion detection sensor.

The temperature sensor may sense an internal temperature of the dielectric heating unit 200 in a non-contact manner or may contact the dielectric heating unit 200 to thus directly obtain a temperature of a resonator. According to an embodiment, the temperature sensor may also sense the temperature of the aerosol generating article 10. In addition, the temperature sensor may be arranged adjacent to the battery 107 and obtain the temperature thereof. The processor 101 may control the power supplied to the dielectric heating unit 200, based on temperature information of the temperature sensor.

The puff sensor may detect a user's puff. The puff sensor may sense a user's puff on the basis of at least one of a temperature change, a flow change, a power change, and a pressure change. The processor 101 may control the power supplied to the dielectric heating unit 200, based on puff information from the puff sensor. For example, the processor 101 may count the number of puffs, and when the number of puffs reaches a preset maximum number of puffs, the processor 101 may block the power supplied to the dielectric heating unit 200. As another example, the processor 101 may block the power supplied to the dielectric heating unit 200 when no puffs are sensed for a certain period of time.

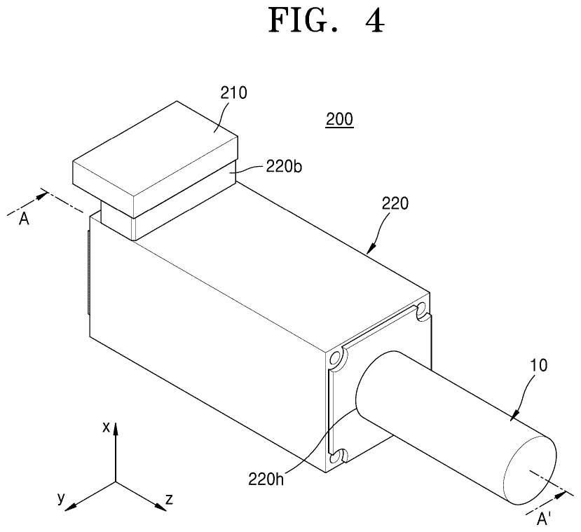

The insertion detection sensor may be arranged inside or adjacent to an accommodation space (220h of FIG. 4) and thus may detect the insertion and removal of the aerosol generating article 10 accommodated in the accommodation space 110h. For example, the insertion detection sensor may include an inductive sensor and/or a capacitance sensor. When the aerosol generating article 10 is inserted into the accommodation space 110h, the processor 101 may supply power to the dielectric heating unit 200.

According to an embodiment, the sensor unit 104 may additionally include a reuse detection sensor, a motion detection sensor, a humidity sensor, a barometric pressure sensor, a magnetic sensor, a cover detachment detection sensor, a location sensor (a global positioning system (GPS)), a proximity sensor, and the like. Because a function of each of sensors may be intuitively inferred from the name of the sensor, a detailed description thereof may be omitted.

The communication unit 105 may include at least one communication module for communication with external electronic device. The processor 101 may control the communication unit 105 and transmit information regarding the aerosol generating device 100 to the external electronic device. Alternatively, the processor 101 may receive information from the external electronic device through the communication unit 105 and control the components included in the aerosol generating device 100. For example, information exchanged between the communication unit 105 and the external electronic device may include user authentication information, firmware update information, and user's smoking pattern information.

The memory 106 may be a hardware component that stores various types of data processed in the aerosol generating device 100 and may store data processed and data to be processed by the processor 101. For example, the memory 106 may store an operation time of the aerosol generating device 100, the maximum number of puffs, the current number of puffs, at least one temperature profile, data on a user's smoking pattern, etc.

The battery 107 may supply power to the dielectric heating unit 200 to heat the aerosol generating article 10. In addition, the battery 107 may supply power required for operations of other components included in the aerosol generating device 100. The battery 107 may be a rechargeable battery or a separable and detachable battery.

The interface unit 108 may include a connection terminal that may be physically connected to the external electronic device. The connection terminal may include at least one of a High-Definition Multimedia Interface (HDMI) connector, a Universal Serial Bus (USB) connector, a Secure Digital (SD) card connector, and an audio connector (e.g., a headphone connector) or a combination thereof. The interface unit 108 may exchange information with the external electronic device through the connection terminal or charge power.

The power converter 109 may convert direct current power from the battery 107 into alternating current power. In addition, the power converter 109 may supply the converted alternating current power to the dielectric heating unit 200. The power converter 109 may be an inverter including at least one switching device, and the processor 101 may control the ON/OFF state of the switching device included in the power converter 109 and convert direct current power into alternating current power. The power converter 109 may be implemented as a full bridge or a half bridge.

The dielectric heating unit 200 may heat the aerosol generating article 10 by using a dielectric heating method. The dielectric heating unit 200 may correspond to the heater assembly 200 of FIG. 1.

The dielectric heating unit 200 may use microwaves and/or an electric field of microwaves (hereinafter, referred to as microwaves or microwave power when no classification is required) to heat the aerosol generating article 10. The heating method of the dielectric heating unit 200 may include heating a heating object by producing microwaves in a resonance structure, rather than radiating microwaves by using an antenna. The resonance structure is described below with reference to FIG. 4 and subsequent figures.

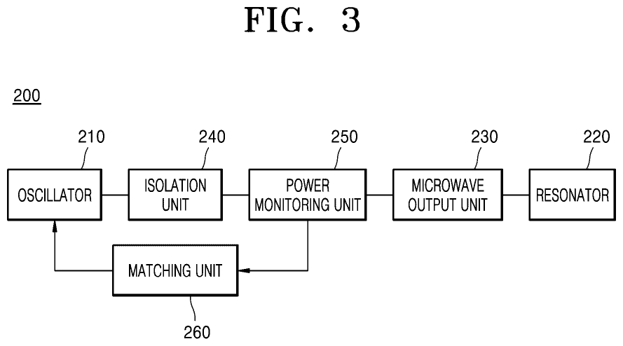

The dielectric heating unit 200 may output high-frequency microwaves to a resonating unit (220 of FIG. 3). Microwaves may be power in an Industrial Scientific and Medical (ISM) band allowed for heating, but one or more embodiments are not limited thereto. The resonating unit 220 may be designed by taking the wavelength of the microwaves into account to facilitate the resonance of the microwaves within the resonating unit 220.

The aerosol generating article 10 may be inserted into the resonating unit 220, and a dielectric material in the aerosol generating article 10 may be heated by the resonating unit 220. For example, the aerosol generating article 10 may include a polar substance, and molecules in the polar substance may be polarized in the resonating unit 220. The molecules may vibrate or rotate due to polarization, and the aerosol generating article 10 may be heated by frictional heat generated during the vibration or rotation. Part of power output to the resonator 220 may be used to heat the aerosol-generating article 10 inserted into the resonator 220, while the remainder of the power may be converted into thermal energy and released to the outside of the resonator 220. The dielectric heating unit 200 is described in more detail with reference to FIG. 3.

The processor 101 may control general operations of the aerosol generating device 100. The processor 101 may be implemented as an array of a plurality of logic gates or as a combination of a general-purpose microprocessor and a memory in which a program executable in the microprocessor is stored. Also, the processor 101 may be implemented in other forms of hardware.

The processor 101 may control direct current power supplied from the battery 107 to the power converter 109 and/or alternating current power supplied from the power converter 109 to the dielectric heating unit 200, according to power required for the dielectric heating unit 200. In an embodiment, the aerosol generating device 100 may include a converter that increases or decreases direct current power, and the processor 101 may control the converter to adjust the magnitude of the direct current power. Additionally, the processor 101 may adjust a switching frequency and a duty ratio of the switching device included in the power converter 109, thus controlling the alternating current power supplied to the dielectric heating unit 200.

The processor 101 may control microwave power of the dielectric heating unit 200 and a resonance frequency of the dielectric heating unit 200, thereby controlling a heating temperature of the aerosol generating article 10. Therefore, an oscillating unit 210, an isolation unit 270, a power monitoring unit 250, and a matching unit 260 of FIG. 3 described below may be some components of the processor 101.

The processor 101 may control microwave power of the dielectric heating unit 200 based on temperature profile information stored in the memory 106. In other words, a temperature profile may include information regarding a target temperature of the dielectric heating unit 200 over time, and the processor 101 may control the microwave power of the dielectric heating unit 200 over time.

The processor 101 may adjust the frequency of the microwaves to make the resonance frequency of the dielectric heating unit 200 uniform. The processor 101 may track a change in the resonance frequency of the dielectric heating unit 200 in real time as the heating object is heated, and may control the dielectric heating unit 200 to output a microwave frequency according to the changing resonance frequency. In other words, the processor 101 may adjust the microwave frequency in real time, irrespective of the temperature profile stored in advance.

FIG. 3 is an internal block diagram of the dielectric heating unit of FIG. 2.

Referring to FIG. 3, the dielectric heating unit 200 may include the oscillating unit 210, the isolation unit 270, the power monitoring unit 250, the matching unit 260, a microwave output unit 230, and the resonating unit 220. However, components of the dielectric heating unit 200 are not limited to that illustrated in FIG. 3. Depending on design of the dielectric heating unit 200, some of the components illustrated in FIG. 3 may be omitted or new component may be added.

The oscillating unit 210 may receive alternating current power from the power converter 109 and generate high-frequency microwave power. According to an embodiment, the power converter 109 may be included in the oscillating unit 210. Microwave power may be selected from the frequency bands, such as 915 MHz, 2.45 GHZ, and 5.8 GHz, which are included in the ISM bands.

The oscillating unit 210 may include a solid-state-based RF generating device and generate microwave power by using the same. The solid-state-based RF generating device may be realized as a semiconductor. When the oscillating unit 210 is implemented as a semiconductor, the dielectric heating unit 200 may be miniaturized, and the lifespan of the device may be extended.

The oscillating unit 210 may output microwave power to the resonating unit 220. The oscillating unit 210 may include a power amplifier that increases or decreases the microwave power, and the power amplifier may adjust the magnitude of the microwave power under the control by the processor 101. For example, the power amplifier may decrease or increase the amplitude of microwaves. As the amplitude of microwaves is adjusted, the microwave power may also be adjusted.

The processor 101 may adjust the magnitude of the microwave power output from the oscillating unit 210, based on the temperature profile stored in advance. For example, the temperature profile may include target temperature information according to the preheating section and the smoking section, and the oscillating unit 210 may supply microwave power at a first power level in the preheating section and supply microwave power at a second power level in the smoking section, wherein the second power level is less than the first power level.

The isolation unit 270 may block the microwave power that is input to the oscillating unit 210 from the resonating unit 220. Most of the microwave power that is output from the oscillating unit 210 is absorbed into the heating object, but depending on the heating characteristics of the heating object, part of the microwave power may be reflected from the heating object and transmitted back towards the oscillating unit 210. This occurs due to a change in the impedance measured from the oscillating unit 210 to the resonating unit 220 as polar molecules are depleted while the heating object is heated. The description that ‘the impedance from the oscillating unit 210 to the resonating unit 220 changes’ may be the same as the description that ‘the resonance frequency of the resonating unit 220 changes.’ When the microwave power reflected from the resonating unit 220 is input to the oscillating unit 210, the oscillating unit 210 may not only malfunction but also fail to achieve expected output performance. The isolation unit 270 may not redirect the microwave power, which is reflected from the resonating unit 220, to the oscillating unit 210 and may guide the microwave power in a certain direction to absorb the same. To this end, the isolation unit 270 may include a circulator and a dummy load.

The power monitoring unit 250 may monitor the microwave power, which is output from the oscillating unit 210, and the reflected microwave power, which is reflected from the resonating unit 220, respectively. The power monitoring unit 250 may transmit information regarding the microwave power and the reflected microwave power to the matching unit 260.

The matching unit 260 may match the impedance measured from the oscillating unit 210 to the resonating unit 220 with the impedance measured from the resonating unit 220 to the oscillating unit 210 to minimize the reflected microwave power. Impedance matching may indicate that the frequency of the oscillating unit 210 aligns with the resonance frequency of the resonating unit 220. Therefore, the matching unit 260 may vary the frequency of the oscillating unit 210 to match the impedance. In other words, the matching unit 260 may adjust the frequency of the microwave power that is output from the oscillating unit 210 to minimize the reflected microwave power. The impedance matching by the matching unit 260 may be performed in real time regardless of the temperature profile.

The oscillating unit 210, the isolation unit 270, the power monitoring unit 250, and the matching unit 260 described above may be distinct from the microwave output unit 230 and the resonating unit 220 below and may be implemented as microwave sources in the form of chips. According to an embodiment, the oscillating unit 210, the isolation unit 270, the power monitoring unit 250, and the matching unit 260 may be implemented as some components of the processor 101.

The microwave output unit 230 may be a component configured to input the microwave power to the resonating unit 220 and may correspond to a coupler shown in FIG. 3 and subsequent figures. The microwave output unit 230 may be implemented in the form of SubMiniature version A (SMA), SubMiniature version B (SMB), Micro Coaxial (MCX), and Micro-Miniature coaxial (MMCX) connectors. The microwave output unit 230 may connect the resonating unit 220 to a chip-shaped microwave source and deliver microwave power generated from the microwave source to the resonating unit 220.

The resonating unit 220 may form microwaves within the resonance structure, thus heating the heating object. The resonating unit 220 may include an accommodation space where the aerosol generating article 10 is accommodated, and the aerosol generating article 10 may be exposed to microwaves and dielectric-heated. For example, the aerosol generating article 10 may include a polar substance, and molecules in the polar substance may be polarized by the microwaves within the resonating unit 220. The molecules may vibrate or rotate due to polarization, and the aerosol generating article 10 may be heated by frictional heat generated during the vibration or rotation.

The resonating unit 220 may include at least one internal conductor to resonate microwaves, and depending on the arrangement, thickness, length, and the like of the internal conductor, the microwaves may resonate within the resonating unit 220.

The resonating unit 220 may be designed by taking the wavelength of the microwaves into account to facilitate the resonance of the microwaves within the resonating unit 220. For the resonance of the microwaves within the resonating unit 220, there is a need for a closed end/short end with a closed cross-section and an open end with at least one open portion on the opposite side. In addition, the length between the closed end/short end and the open end must be set to an integer multiple of ¼ of the microwave wavelength. The resonating unit 220 selects a length equal to 1/4 of the microwave wavelength to ensure device miniaturization. In other words, the length between the closed end/short end and the open end of the resonating unit 220 may be set to ¼ of the microwave wavelength.

The resonating unit 220 may include a dielectric accommodation space. The dielectric accommodation space is separate from the accommodation space of the aerosol generating article 10 and contains a material that may reduce the size of the resonating unit 220 by changing the overall resonance frequency of the resonating unit 220. In an embodiment, dielectric materials with low microwave absorption may be accommodated in the dielectric accommodation space. Such accommodation is intended to prevent energy, which should be delivered to the heating object, from being transferred to the dielectric materials and causing the dielectric materials to generate heat. Microwave absorbance may be expressed as a loss tangent that is a ratio of a real part of a complex dielectric constant to an imaginary part thereof. In an embodiment, dielectric materials with a loss tangent of a preset value or less may be accommodated in the dielectric accommodation space 227, and the preset value may be 1/100. For example, the dielectric material may include at least any one of quartz, tetrafluoroethylene, and aluminum oxide, or a combination thereof, but one or more embodiments are not limited thereto.

FIG. 4 may show an embodiment of the heater assembly 200 and the dielectric heating unit 200 described above, and repeated description is omitted.

The oscillating unit 210 may generate microwaves in a designated frequency band as power is supplied. The microwaves generated by the oscillating unit 210 may be transferred to the resonating unit 220 through a coupler (not shown).

FIG. 4 may show an embodiment of the heater assembly 200 and the dielectric heating unit 200 described above, and repeated description is omitted. The oscillating unit 210 may generate microwaves in a designated frequency band as power is supplied. For example, as power is supplied, the oscillator 210 may generate microwaves in the ISM band allowed for heating, and the generated microwaves may be transmitted to the resonator 220. In this process, part of the power supplied to the oscillator 210 may be used to generate microwaves, while the remainder of the power may not be used to generate microwaves and may be converted into thermal energy.

The resonance unit 220 may include an accommodation space 220h for receiving at least a portion of the aerosol-generating article 10 and may heat the aerosol-generating article 10 using a dielectric heating method by resonating microwaves generated by the oscillation unit 210. For example, charges of glycerin included in the aerosol generating article 10 may vibrate or rotate due to the resonance of the microwaves, and frictional heat generated during such vibration or rotation may cause heat to be produced in the glycerin such that aerosol generating article 10 may be heated.

According to an embodiment, the resonating unit 220 may include a material with low microwave absorption to prevent the microwaves, generated by the oscillating unit 210, from being absorbed into the resonating unit 220.

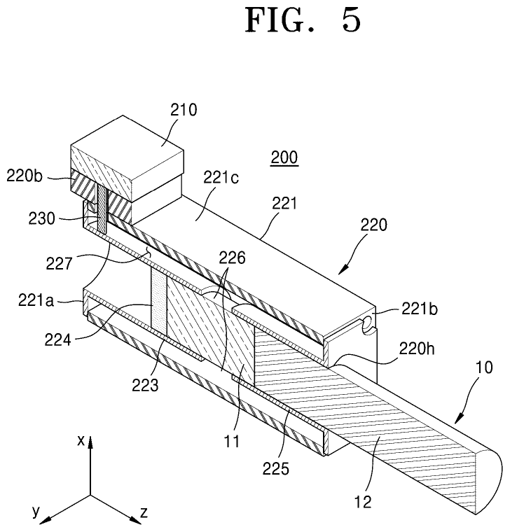

Hereinafter, the detailed structure of the resonating unit 220 of the heater assembly 200 is described with reference to FIG. 5.

FIG. 5 is a cross-sectional view of the heater assembly of FIG. 4. FIG. 5 shows a cross-section of the heater assembly 200 of FIG. 4, taken along a direction A-A′.

Referring to FIG. 5, the heater assembly 200 according to an embodiment may include the oscillating unit 210, the resonating unit 220, and a coupler 230. The components of the heater assembly 200 may be the same as or similar to at least one of the components of the heater assembly 200 of FIG. 4, and repeated description is omitted hereinafter.

The oscillating unit 210 may generate microwaves in a designated frequency band as an alternating current voltage is applied, and the microwaves generated by the oscillating unit 210 may be delivered to the resonating unit 220 through the coupler 230. For example, as power is supplied, the oscillator 210 may generate microwaves in the ISM band allowed for heating, and the generated microwaves may be transmitted to the resonator 220. In this process, part of the power supplied to the oscillator 210 may be used to generate microwaves, while the remainder of the power may not be used to generate microwaves and may be converted into thermal energy and released from the heater assembly 200 to the outside. Due to released heat, constituting elements inside the heater assembly 200 may break down or malfunction. In addition, when the heater assembly 200 generates heat at an excessively high temperature, a user who uses an aerosol-generating device (e.g.: the aerosol-generating device 100 of FIG. 1) that includes the heater assembly 200 may suffer from burns on their hands due to the heat generated by the heater assembly 200.

According to an embodiment, the oscillating unit 210 may be fixed to the resonating unit 220 to prevent separation from the resonating unit 220 while the aerosol generating device is used. In an embodiment, the oscillating unit 210 may be supported by brackets 220b protruding along the x direction on a portion of the resonating unit 220, thus being fixed to the resonating unit 220. In another embodiment, the oscillating unit 210 may be fixed to a portion of the resonating unit 220 without the brackets 220b.

In the drawing, the oscillating unit 210 is fixed to a portion of the resonating unit 220 that faces the x direction, but the position of the oscillating unit 210 is not limited thereto. In another embodiment, the oscillating unit 210 may be fixed to another portion of the resonating unit 220 that faces in the-z direction.

The resonating unit 220 may be arranged to surround at least a portion of the aerosol generating article 10 inserted into the aerosol generating device and may heat the aerosol generating article 10 by using the microwaves generated by the oscillating unit 210. For example, dielectric materials included in the aerosol generating article 10 may generate heat because of the electric field generated in the resonating unit 220 due to the microwaves, and the aerosol generating article 10 may be heated by the heat generated in the dielectric materials.

According to an embodiment, the aerosol generating article 10 may include a tobacco rod 11 and a filter rod 12.

The tobacco rod 11 may include an aerosol generating material and may be formed as a sheet, a strand, or a pipe tobacco formed of tiny bits cut from a tobacco sheet. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 11 may include other additives, such as flavors, a wetting agent, and/or organic acid. Also, the tobacco rod 11 may include a flavored liquid, such as menthol or a moisturizer, which is injected to the tobacco rod 11.

The filter rod 12 may include a cellulose acetate filter. Shapes of the filter rod 12 are not limited. For example, the filter rod 12 may include a cylinder-type rod or a tube-type rod having a hollow inside. Also, the filter rod 12 may include a recess-type rod. When the filter rod 12 includes a plurality of segments, at least one of the plurality of segments may have a different shape.

At least part (e.g., glycerin) of the aerosol generating material included in the aerosol generating article 10 may be a dielectric material with polarity in an electric field, and the at least part of the aerosol generating material may generate heat in a dielectric heating method, thereby heating the aerosol generating article 10.

According to an embodiment, the resonating unit 220 may include an outer conductor 221, a first internal conductor 223, and a second internal conductor 225.

The outer conductor 221 may form the overall exterior of the resonating unit 220 and have a shape with a hollow space therein; thus, the components of the resonating unit 220 may be arranged inside the outer conductor 221. The outer conductor 221 may include the accommodation space 220h where the aerosol generating article 10 may be accommodated, and the aerosol generating article 10 may be inserted into the outer conductor 221 through the accommodation space 220h.

According to an embodiment, the outer conductor 221 may include a first surface 221a, a second surface 221b facing the first surface 221a, and side surfaces 221c surrounding an empty space between the first surface 221a and the second surface 221b. At least a portion (e.g., the first internal conductor 223 and the second internal conductor 225) of the components of the resonating unit 220 may be arranged in the inner space of the resonating unit 220 formed by the first surface 221a, the second surface 221b, and the side surfaces 221c.

The first internal conductor 223 may be shaped as a hollow cylinder extending in a direction towards the inner space of the outer conductor 221 from the first surface 221a of the outer conductor 221.

According to an embodiment, a portion of the first internal conductor 223 may contact the coupler 230 connected to the oscillating unit 210, and the microwaves generated by the oscillating unit 210 may be transferred to the first internal conductor 223 through the coupler 230. For example, the coupler 230 may penetrate the outer conductor 221 and may be arranged so that one end of the coupler 230 contacts the oscillating unit 210 and the other end contacts a portion of the first internal conductor 223, and the microwaves generated by the oscillating unit 210 may be transferred to the first internal conductor 223 through the coupler 230.

In this case, the coupler 230 may be arranged not to contact the outer conductor 221 but to penetrate the same to transfer the microwaves, but the arrangement of the coupler 230 is not limited thereto as long as the microwaves generated by the oscillating unit 210 may be delivered to the first internal conductor 223.

A first area formed between the outer conductor 221 and the first internal conductor 223 may function as a ‘first resonator’ that generates an electric field through microwave resonance. The first area may refer to the space formed by the first surface 221a and the side surfaces 221c of the outer conductor 221 and the first internal conductor 223, and within the first area, an electric field may be generated as the microwaves transmitted through the coupler 230 resonate.

The second internal conductor 225 may be shaped as a hollow cylinder extending in a direction towards the inner space of the outer conductor 221 from the second surface 221b of the outer conductor 221. The second internal conductor 225 may be spaced apart from the first internal conductor 223 by a certain distance within the inner space of the outer conductor 221, and there may be a gap between the first internal conductor 223 and the second internal conductor 225.

A second area formed between the outer conductor 221 and the second internal conductor 225 may function as a ‘second resonator’ that generates an electric field through microwave resonance. The second internal conductor 225 may be coupled to the first internal conductor 223 (e.g., capacitive coupling), and when an electric field is generated in the first area because of the above coupling relationship, an induced electric field may be generated even in the second area. In the present specification, the term ‘capacitive coupling’ may refer to a coupling relationship in which energy may be transferred due to capacitance between two conductors.

For example, as the microwaves generated by the oscillating unit 210 are delivered to the first internal conductor 223, an electric field may be generated in the first area due to resonance, and an induced electric field may be generated in the second area that is formed by the second internal conductor 225 coupled to the outer conductor 221 and the first internal conductor 223.

According to an embodiment, the first area and the second area of the resonating unit 220 may operate as resonators with a length equal to a quarter of the microwave wavelength 2.

In an embodiment, one end of the first area (e.g., an end in the-z direction) may be formed as a closed end/short end as the cross-section of the first area is closed by the first surface 221a of the outer conductor 221, and the other end of the first area (e.g., an end in the z direction) may be formed as an open end because the first surface 221a is not present, leaving the cross-section open. As another example, one end of the second area (e.g., an end in the-z direction) may be formed as an open end as the cross-section is open, and the other end of the second area (e.g., an end in the z direction) may be formed as a closed end/short end as the cross-section of the second area is closed by the second surface 221b of the outer conductor 221.

In other words, when viewed in an xz plane, the first area and the second area may each include a closed end/short end and an open end and may be shaped overall in the form of “ [symbol] ”, and based on the above-described structure, the first area and the second area may each function as a resonator with a length of a quarter of the microwave wavelength.

According to an embodiment, the first internal conductor 223 and the second internal conductor 225 are formed to have the same length with respect to the z axis, and thus, the first area and the second area may be symmetrically arranged; however, one or more embodiments are not limited thereto.

The aerosol generating article 10 inserted into the inner space of the outer conductor 221 through the accommodation space may be surrounded by the first internal conductor 223 and the second internal conductor 225 and may be heated by using a dielectric heating method.

At least a portion of the electric field, which is generated in the first area and/or the second area due to microwave resonance, may propagate towards the inside of the first internal conductor 223 and/or the second internal conductor 225 through the gap 226 between the first internal conductor 223 and/or the second internal conductor 225, and the aerosol generating article 10 surrounded by the first internal conductor 223 and the second internal conductor 225 may be heated by the propagating electric field. For example, dielectric materials included in the aerosol generating article 10 may generate heat because of the electric field propagating through the gap 226, and the aerosol generating article 10 may be heated by the heat generated in the dielectric materials.

The heater assembly 200 according to an embodiment may be designed such that the diameters first internal conductor 223 and the second internal conductor 225 may each fall below a designated value, thereby preventing the electric field, which propagates into the first internal conductor 223 and/or the second internal conductor 225, from leaking to the outside of the heater assembly 200 or the resonating unit 220. In the present specification, the term ‘designated value’ may refer to a diameter value at which the electric field starts leaking to the outside of the first internal conductor 223 and/or the second internal conductor 225. For example, when the diameter of the first internal conductor 223 and/or the second internal conductor 225 has a designated value or more, part of the electric field entering the first internal conductor 223 and/or the second internal conductor 225 may leak to the outside of the resonating unit 220. On the contrary, the heater assembly 200 according to an embodiment may prevent the electric field from propagating to the outside of the resonating unit 220 according to the structure in which the diameters of the first internal conductor 223 and the second internal conductor 225 are less than the designated value, thereby preventing the electric field from leaking to the outside of the heater assembly 200 or the resonating unit 220 without a separate blocking member.

According to an embodiment, the resonating unit 220 may further include a closing unit 224 that is located inside the first internal conductor 223, closes a cross-section of the first internal conductor 223, and restricts a flow direction of the aerosol generated from the aerosol generating article 10. For example, the closing unit 224 may block the flow of the aerosol, which is generated from the aerosol generating article 10, in the-z direction by closing the cross-section of the first internal conductor 223.

When the aerosol generated from the aerosol generating article 10 or droplets, which are generated as the aerosol is liquefied, flow in the-z direction and enter other components of the aerosol generating device (e.g., the aerosol generating device 100 of FIG. 1), malfunction or damage to the components of the aerosol generating device may occur. On the contrary, the heater assembly 200 according to an embodiment restricts the flow direction of the aerosol by using the closing unit 224, thereby preventing malfunction or damage to the components of the aerosol generating device that is caused by the aerosol or droplets.

A heat dissipation member may be arranged inside the resonator 220 and absorb heat inside the resonator 220. For example, the heat dissipation member may be arranged inside the first internal conductor 223 and arranged to be in contact with one surface of the closure 224. As the oscillator 210 generates high-frequency microwave power, a large amount of heat may be generated inside the resonator 220. Part of the generated het may be used to heat the aerosol-generating article 10 inserted into the resonator 220, and the remainder of the generated heat may be released to the outside of the resonator 220.

The heat dissipation member may take heat away from the inside of the resonator 220 and release the heat to a region surrounding the heat dissipation member. For example, the heat dissipation member may act as a heat sink for the heat released to the outside of the resonator 220, and the heat dissipation member may release the absorbed heat toward a medium (e.g.: the aerosol-generating article 10) with a relatively lower temperature. The heater assembly 200 according to an embodiment may improve the overall heating efficiency of the resonator 220 through the heat dissipation member.

The aerosol-generating article 10 inserted into the internal space of the outer conductor 221 through the housing space 220h may be surrounded by the first internal conductor 223 and the second internal conductor 225 and heated by dielectric heating. For example, a portion of the aerosol-generating article 10 inserted into the internal space of the outer conductor 221 may be arranged inside the first internal conductor 223 and the second internal conductor 225, while another portion may be arranged outside the first internal conductor 223 and the second internal conductor 225. A dielectric material included in the aerosol-generating article 10 generates heat due to electric fields generated inside and outside the first internal conductor 223 and/or the second internal conductor 225, and thus, the aerosol-generating article 10 may be heated.

According to an embodiment, when the aerosol-generating article 10 is inserted into the resonator 220 through the housing space 220h, the tobacco rod 11 of the aerosol-generating article 10 may be arranged at a position corresponding to the gap 226 between the first internal conductor 223 and the second internal conductor 225.

As the electric field generated in the first region and the electric field generated in the second region flow into the first internal conductor 223 and/or the second internal conductor 225 through the gap 226, the strongest electric field may be generated in a region surrounding the gap 226 within an internal region of the resonator 220. In the heater assembly 200 according to an embodiment, by arranging the tobacco rod 11, which includes a dielectric material that generates heat due to an electric field, at a position corresponding to the gap 226 where the electric field is the strongest, heating efficiency (or “dielectric heating efficiency”) of the heater assembly 200 may be improved.

According to an embodiment, the resonance unit 220 may further include a dielectric accommodation space 227 for accommodating a dielectric therein. The dielectric accommodation space 227 may be formed in an empty space between the outer conductor 221 and the first internal conductor 223 and the second internal conductor 225, and a dielectric with a low microwave absorptivity may be accommodated in the dielectric accommodation space 227. For example, a dielectric may be at least one of quartz, tetrafluoroethylene, or aluminum oxide, or a combination thereof, but the disclosure is not limited thereto.

In the heater assembly 200 according to an embodiment, a dielectric may be arranged inside the dielectric accommodation space 227 so that an overall size of the resonance unit 220 may be reduced while generating the same electric field as the resonance unit 220 which does not include a dielectric. In other words, in the heater assembly 200 according to an embodiment, due to the dielectric arranged inside the dielectric accommodation space 227, the size of the resonance unit 220 may be reduced so that a mounting space of the resonance unit 220 within the aerosol generating device may also be reduced, and as a result, the aerosol generating device may become more compact.

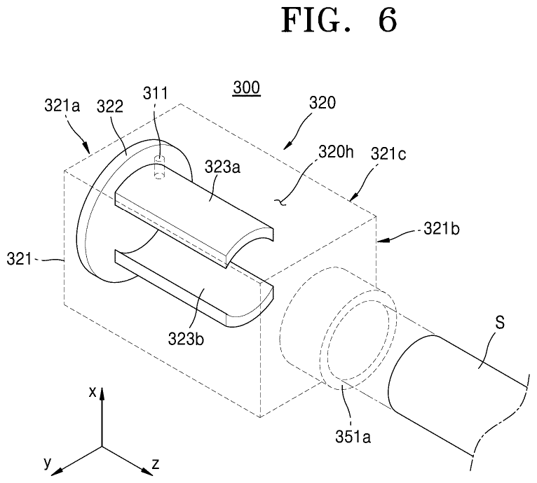

FIG. 6 is a perspective view of a heater assembly according to another embodiment.

Referring to FIG. 6, a heater assembly 300 according to another embodiment may include a resonator 320 and a coupler 311. Constituting elements of the heater assembly 300 may be identical or similar to at least one of the constituting elements of the heater assembly 200 of FIGS. 4 and 5, and hereinafter, redundant descriptions thereof are omitted.

The resonator 320 may include an outer conductor 321, a plurality of first internal conductors 323a and 323b, and a closure 322.

The coupler 311 may supply microwaves to at least one of the plurality of first internal conductors 323a and 323b to allow the resonator 320 to generate microwave resonance.

The outer conductor 321 may form the overall appearance of the resonator 320, and an interior thereof is hollow so that constituting elements of the resonator 320 may be arranged therein. For example, the outer conductor 321 may be formed as a quadrangular pillar with an overall square cross-section, but the present disclosure is not limited thereto. As another example, the outer conductor 321 may be formed as a polygonal pillar with a rectangular, elliptical, or circular cross-section.

The outer conductor 321 may include a housing space 320h in which the aerosol-generating article 10 may be accommodated and a support 351a capable of supporting the aerosol-generating article 10 inserted into the housing space 320h. One region of the aerosol-generating article 10 may be inserted into the outer conductor 321 through the housing space 320h, while another region of the aerosol-generating article 10 may be exposed to the outside of the resonator 320. The support 351a may support the other region of the aerosol-generating article 10, which is exposed to the outside of the resonator 320.

The outer conductor 321 may include a first surface 321a, a second surface 321b facing the first surface 321a, and a side surface 321c surrounding an empty space between the first surface 321a and the second surface 321b. At least some (e.g.: the first internal conductors 323a and 323b) of the constituting elements of the resonator 320 may be arranged in an internal space of the resonator 320, which is formed by the first surface 321a, the second surface 321b, and the side surface 321c.

The plurality of first internal conductors 323a and 323b may each be formed to have a plate shape extending from the first surface 321a of the outer conductor 321 toward an internal space of the outer conductor 321. For example, the plurality of first internal conductors 323a and 323b may be spaced apart from each other in a circumferential direction of the aerosol-generating article 10 accommodated in the housing space 320h, wherein one (e.g.: the first internal conductor 323a) of the plurality of first internal conductors 323a and 323b may be arranged to surround one region of the aerosol-generating article 10, while the other (e.g.: the first internal conductor 323b) may be arranged to surround another region of the aerosol-generating article 10.

One region of the first internal conductor 323a may be in contact with the coupler 311 connected to an oscillator, and as microwaves transmitted through the coupler 311 resonate, an electric field may be generated inside the plurality of first internal conductors 323a and 323b. For example, the coupler 311 may pass through the outer conductor 321 and may be arranged to have one end in contact with the oscillator and the other end in contact with the one region of the first internal conductor 323a, and as microwaves generated by an oscillator 310 are transmitted to the first internal conductor 323a through the coupler 311, an electric field may be generated inside the plurality of first internal conductors 323a and 323b.

The resonator 320 may include a short end having a closed cross-section and an open end arranged opposite to the short end and having at least one open cross-sectional region, so as to have a length of ¼ of a wavelength (2) ( 2/4) of a microwave.

The resonator 320 may include the closure 322 that is arranged to be in contact with one end of each of the plurality of first internal conductors 323a and 323b and closes a cross-section of each of the plurality of first internal conductors 323a and 323b. As the cross-section of the one end of each of the plurality of first internal conductors 323a and 323b is closed by the closure 322, a short end may be formed at the one end of each of the plurality of first internal conductors 323a and 323b. Because the other end of each of the plurality of first internal conductors 323a and 323b is spaced apart from the closure 322 so as not to be in contact with the closure 322, an open end may be formed at the other end of each of the plurality of first internal conductors 323a and 323b. In other words, when viewed in an xz plane, the plurality of first internal conductors 323a and 323b may be formed to have a “⊏” shape overall and thus may include a short end and an open end, and due to the aforementioned structure of the plurality of first internal conductors 323a and 323b, the plurality of first internal conductors 323a and 323b may function as a resonator having a length of a quarter-wavelength of a microwave.

Microwave resonance may be respectively formed between the first internal conductor 323a and the outer conductor 321, between the first internal conductor 323b and the outer conductor 321, and between the first internal conductor 323a and the first internal conductor 323b. Accordingly, electric fields may be respectively generated between the first internal conductors 323a and 323b and the outer conductor 321.

Two first internal conductors 323a and 323b are shown in the drawing, but the present disclosure is not limited thereto, and as another example, the number of first internal conductors may be three, or may be four or more.

A triple resonance mode may be formed inside the resonator 320. For example, a resonance of a transverse electric and magnetic (TEM) mode of a microwave may be formed in the plurality of first internal conductors 323a and 323b, and a resonance of a TEM mode different from the resonance inside the plurality of first internal conductors 323a and 323b may be formed between the first internal conductor 323a and the outer conductor 321 and between the first internal conductor 323b and the outer conductor 321. Because the triple resonance mode is formed inside the resonator 320, the aerosol-generating article 10 accommodated inside the resonator 320 may be heated more uniformly.

Due to the resonance structure of the resonator 320, the electric fields may not propagate to a region outside the resonator 320. Therefore, even without a separate shielding member for shielding an electric field, the heater assembly 300 may prevent the electric fields from leaking to the outside of the heater assembly 300.

A resonance peak may be formed at the other end of each of the plurality of first internal conductors 323a and 323b, resulting in a stronger electric field compared to other regions, and by arranging the tobacco rod 11, which includes a dielectric material capable of generating heat due to an electric field, at a position corresponding to a region where the electric field is the strongest, heating efficiency (or “dielectric heating efficiency”) of the heater assembly 300 may be improved.

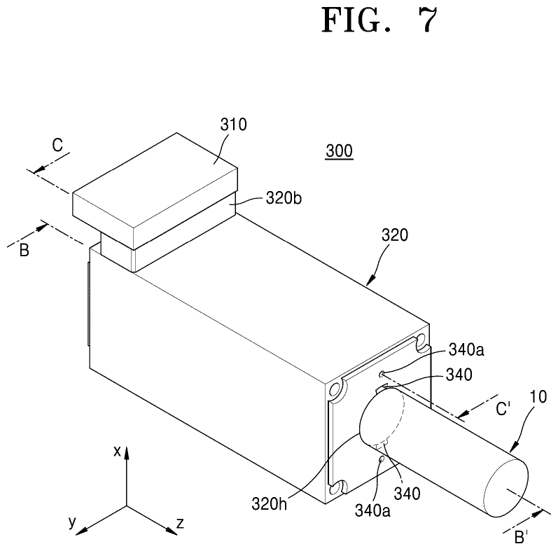

FIG. 7 is a perspective view of a heater assembly according to another embodiment.

Referring to FIG. 7, the heater assembly 300 according to another embodiment may include the oscillator 310 (e.g.: the oscillator 210 of FIGS. 4 and 5), the resonator 320 (e.g.: the resonators 220 and 320 of FIGS. 4 to 6), a first airflow passage 340, and a second airflow passage 340a. The heater assembly 300 according to another embodiment may be an assembly in which the first airflow passage 340 and the second airflow passage 340a are added to the heater assemblies 201 and 300 of FIGS. 4 to 6, and hereinafter, redundant descriptions may be omitted. As power is supplied, the oscillator 310 may generate microwaves in a designated frequency band. The microwaves generated by the oscillator 310 may be transmitted to the resonator 320 through a coupler connecting the oscillator 310 to the resonator 320. For example, as power is supplied, the oscillator 210 may generate microwaves in the ISM band allowed for heating, and the generated microwaves may be transmitted to the resonator 220.

The resonator 320 may include the housing space 320h (e.g.: the housing space 220h of FIGS. 4 and 5) for accommodating at least a portion of the aerosol-generating article 10, and may heat the aerosol-generating article 10 through dielectric heating by resonating the microwaves generated by the oscillator 310. For example, due to the resonance of the microwaves, charges of a dielectric material (e.g.: glycerin) included in the aerosol-generating article 10 accommodated inside the resonator 320 may oscillate or rotate, and due to frictional heat generated during the oscillation or rotation of the charges, heat may be generated in the dielectric material, and thus, the aerosol-generating article 10 may be heated.

Part of the power supplied to the oscillator 210 may be used to heat the aerosol-generating article 10 by generating microwaves, while the reminder of the power may be converted into thermal energy and released from the heater assembly 300 to the outside. Due to released heat, constituting elements inside the heater assembly 300 may break down or malfunction. In addition, when the heater assembly 300 generates heat at an excessively high temperature, a user who uses an aerosol-generating device (e.g.: the aerosol-generating device 100 of FIG. 1) that includes the heater assembly 300 may suffer from burns on their hands due to the heat generated by the heater assembly 300.

The first airflow passage 340 may guide a direction of air movement such that air outside the heater assembly 300 or the resonator 320 (hereinafter, referred to as “external air”) flows into the housing space 320h. For example, the first airflow passage 340 may be arranged in one region of the resonator 320 to connect an exterior of the resonator 320 to the housing space 320h, and the external air may move along the first airflow passage 340 and flow into the housing space 320h. After moving into the housing space 320h, the external air may flow into the aerosol-generating article 10, an aerosol may be generated by mixing the external air introduced into the aerosol-generating article 10 with vapor generated by heating the aerosol-generating article 10, and the generated aerosol may pass through the aerosol-generating article 10 and be released to the outside of the heater assembly 300.

The second airflow passage 340a may guide a direction of air movement such that the external air flows into the resonator 320. For example, the second airflow passage 340a may be arranged in one region of the resonator 320 to connect the exterior of the resonator 320 to an interior of the resonator 320, and the external air may move along the second airflow passage 340a and flow into the resonator 320. After moving into the resonator 320, the external air may flow into a first internal conductor (e.g.: the first internal conductors 223, 323a, and 323b of FIGS. 4 to 6) or a dielectric material housing space. After moving into the first internal conductor or the dielectric material housing space, the external air may flow into the housing space 320h, and the external air introduced into the housing space 320h may flow into the aerosol-generating article 10 and be mixed with vapor generated by heating the aerosol-generating article 10, thereby generating an aerosol. The generated aerosol may pass through the aerosol-generating article 10 and be released to the outside of the heater assembly 300.

Because heat generated in the heater assembly 300 may be effectively released through the first airflow passage 340 or the second airflow passage 340a, external heat release of the heater assembly 300 may be minimized.

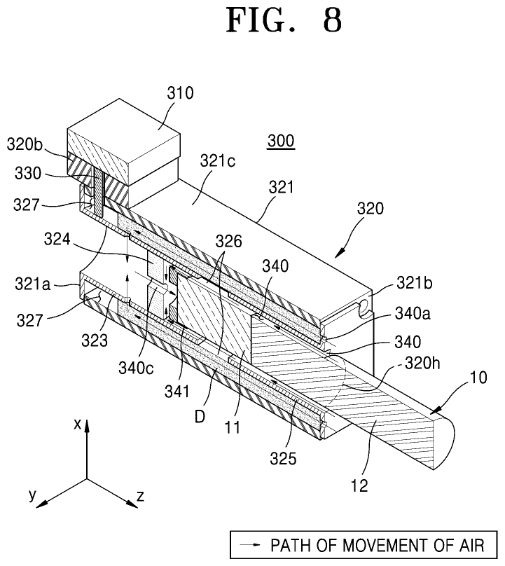

Hereinafter, the arrangement of the first airflow passage 340 and the second airflow passage 340a is described in detail with reference to FIG. 8.

FIG. 8 is a cross-sectional view of an example of the heater assembly of FIG. 7. FIG. 8 shows a cross-section of the heater assembly 300 of FIG. 7 cut in a B-B′ direction, and arrows in FIG. 8 indicate paths of movement of air (or “external air”).

Referring to FIG. 8, the heater assembly 300 according to another embodiment may include the oscillator 310 (e.g.: the oscillator 210 of FIGS. 4 and 5), the resonator 320 (e.g.: the resonators 220 and 320 of FIGS. 4 to 6), the first airflow passage 340, and the second airflow passage 340a.

As a current voltage is applied, the oscillator 310 may generate microwaves in a designated frequency band, and the microwaves generated by the oscillator 310 may be transmitted to the resonator 320 through a coupler 330.

The resonator 320 may be arranged to surround at least one region of the aerosol-generating article 10 inserted into the aerosol-generating device (e.g.: the aerosol-generating device 100 of FIG. 1), and may heat the aerosol-generating article 10 through the microwaves generated by the oscillator 310. For example, dielectric materials included in the aerosol-generating article 10 may generate heat due to an electric field generated inside the resonator 320 due to microwave resonance, and the aerosol-generating article 10 may be heated by the heat generated in the dielectric materials.

According to an embodiment, the resonator 320 may include the outer conductor 321, a first internal conductor 323, and a second internal conductor 325.

The outer conductor 321 may form the overall appearance of the resonator 320, and an interior thereof is hollow so that constituting elements of the resonator 320 may be arranged therein. The outer conductor 321 may include the housing space 320h where at least one region of the aerosol-generating article 10 may be inserted into the outer conductor 321. The housing space 320h may refer to a space formed by the first internal conductor 323 and/or the second internal conductor 325, which are arranged inside the outer conductor 321, and capable of accommodating the aerosol-generating article 10 inserted into the outer conductor 321.

According to an embodiment, the outer conductor 321 may include the first surface 331a, the second surface 331b facing the first surface 331a, and the side surface 331c surrounding an empty space between the first surface 331a and the second surface 331b. At least some (e.g.: the first internal conductor 323, the second internal conductor 325) of the constituting elements of the resonator 320 may be arranged in an internal space of the resonator 320, which is formed by the first surface 331a, the second surface 331b, and the side surface 331c.

The first internal conductor 323 may be formed to have a hollow cylindrical shape extending from the first surface 331a of the outer conductor 321 toward an internal space of the outer conductor 321 or extending in a longitudinal direction of the outer conductor 321.

According to an embodiment, one region of the first internal conductor 323 may be in contact with the coupler 330 connected to the oscillator 310, and the microwaves generated by the oscillator 310 may be transmitted to the first internal conductor 323 through the coupler 330. For example, the coupler 330 may pass through the outer conductor 321 and may be arranged to have one end in contact with the oscillator 310 and the other end in contact with the one region of the first internal conductor 323, and the microwaves generated by the oscillator 310 may be transmitted to the first internal conductor 323 through the coupler 330.

In this case, to transmit the microwaves, the coupler 330 may be arranged to pass through the outer conductor 321 without being in contact with the outer conductor 321, but the arrangement of the coupler 330 is not limited thereto as long as the microwaves generated by the oscillator 310 may be transmitted to the first internal conductor 323.

A first region formed between the outer conductor 321 and the first internal conductor 323 may function as a “first resonator” that generates an electric field through microwave resonance. The first region may refer to a space formed by the first surface 321a and the side surface 321c of the outer conductor 321 and the first internal conductor 323, and inside the first region, the microwaves transmitted through the coupler 330 may resonate, thereby generating an electric field.

The second internal conductor 325 may be formed to have a hollow cylindrical shape extending from the second surface 331b of the outer conductor 321 toward the internal space of the outer conductor 321 or extending in the longitudinal direction of the outer conductor 321. In the internal space of the outer conductor 321, the second internal conductor 325 may be spaced apart by a certain distance from the first internal conductor 323, and a gap 326 may be formed between the first internal conductor 323 and the second internal conductor 325.

A second region formed between the outer conductor 321 and the second internal conductor 325 may function as a “second resonator” that generates an electric field through microwave resonance. The second internal conductor 325 may form a coupling (e.g.: capacitive coupling) with the first internal conductor 323, and when an electric field is generated inside the first region due to the aforementioned coupling relationship, an induced electric field may also be generated inside the second region. In the present disclosure, the “capacitive coupling” may refer to a coupling relationship in which energy may be transferred by capacitance between two conductors.

For example, as the microwaves generated from the oscillator 310 are transmitted to the first internal conductor 323, an electric field may be generated inside the first region due to resonance, and an induced electric field may be generated inside the second region formed by the outer conductor 321 and the second internal conductor 325 coupled with the first internal conductor 323.

According to an embodiment, the first and second regions of the resonator 320 may function as a resonator having a length of ¼ of a wavelength (2) of a microwave.

In an example, one end (e.g.: an end in a-z direction) of the first region may be formed as a short end due to a cross-section of the first region being closed by the first surface 321a of the outer conductor 321, while the other end (e.g.: an end in a z direction) of the first region may be formed as an open end due to a cross-section being opened because the first surface 321a is not present there. In another example, one end (e.g.: an end in the-z direction) of the second region may be formed as an open end due to a cross-section being opened, while the other end (e.g., an end in the z direction) of the second region may be formed as a short end due to a cross-section of the second region being closed by the second surface 321b of the outer conductor 321.

In other words, when viewed in an xz plane, the first region and the second region may be formed to have a “⊏” shape overall, including the short end and the open end, and due to the aforementioned structure, the first region and the second region may function as a resonator having a length of a quarter-wavelength of a microwave.

According to an embodiment, the first internal conductor 323 and the second internal conductor 325 may be formed to have the same length with respect to a z axis and may be arranged such that the first region and the second region are symmetrical to each other, but the present disclosure is not limited thereto.

The aerosol-generating article 10 inserted into the internal space of the outer conductor 321 through the housing space 320h may be surrounded by the first internal conductor 323 and the second internal conductor 325 and heated by dielectric heating. For example, a portion of the aerosol-generating article 10 inserted into the internal space of the outer conductor 321 may be arranged inside the first internal conductor 323 and the second internal conductor 325, while another portion may be arranged outside the first internal conductor 323 and the second internal conductor 325. A dielectric material included in the aerosol-generating article 10 generates heat due to electric field generated inside and outside the first internal conductor 323 and/or the second internal conductor 325, and thus, the aerosol-generating article 10 may be heated.

According to an embodiment, the resonator 320 may further include a dielectric material housing space 327 and a dielectric material D accommodated in the dielectric material housing space 327 to adjust a dielectric constant of the resonator 320.

The dielectric material housing space 327 may be formed in an empty space between the outer conductor 321 and the first and second internal conductors 323 and 325, and the dielectric material D may be accommodated in the dielectric material housing space 327. For example, the dielectric material D may be at least any one of quartz, tetrafluoroethylene, and aluminum oxide, with low microwave absorption, or a combination thereof, but the type of the dielectric material D is not limited thereto.

By arranging the dielectric material D inside the dielectric material housing space 327, the resonator 320 in the heater assembly 300 according to another embodiment may have a reduced overall size, and an electric field may be generated that is identical to that of the resonator 320 not including a dielectric material. In other words, the heater assembly 200 according to another embodiment may have a reduced mounting space for the resonator 320 within the aerosol-generating device by having a reduced size of the resonator 320 through the dielectric material D arranged inside the dielectric material housing space 327, and as a result, the aerosol-generating device (e.g.: the aerosol-generating device 100 of FIG. 1) may become miniaturized.

According to an embodiment, when the aerosol-generating article 10 is inserted into the resonator 320 through the housing space 320h, the tobacco rod 11 of the aerosol-generating article 10 may be arranged at a position corresponding to the gap 326 between the first internal conductor 323 and the second internal conductor 325.

A resonance peak may be formed at an end portion of the first internal conductor 323, which functions as the first resonator, and at an end portion of the second internal conductor 325, which functions as the second resonator, resulting in a stronger electric field compared to other regions, and as a result, the strongest electric field may be generated in the gap 326 between the first internal conductor 323 and the second internal conductor 325 within the resonator 320. By arranging the tobacco rod 11, which includes a dielectric material that generates heat due to an electric field, at a position corresponding to the gap 326 where the electric field is the strongest, heating efficiency (or “dielectric heating efficiency”) of the heater assembly 300 may be improved. The first airflow passage 340 may be formed inside the first and second internal conductors 323 and 325 of the resonator 320 and may form a path that allows external air to flow into the aerosol-generating article 10 accommodated in the housing space 320h. For example, the first airflow passage 340 may be a flow path that is formed in a space between the first and second internal conductors 323 and 325 and the aerosol-generating article 10 accommodated in the housing space 320h and connects the exterior of the resonator 320 to the aerosol-generating article 10 accommodated in the housing space 320h.

The first airflow passage 340 may be arranged such that external air moves in a longitudinal direction (e.g.: −z direction) of the housing space 320h and then flows into one end (e.g.: an end in the −z direction) of the aerosol-generating article 10 accommodated in the housing space 320h. In other words, the first airflow passage 340 may have one region extending in the longitudinal direction of the housing space 320h and another region formed to extend in a direction intersecting with the longitudinal direction of the housing space 320h and connect the one region of the first airflow passage 340 to an interior of the housing space 320h.

An aerosol may be generated by mixing the external air introduced into the one end of the aerosol-generating article 10 through the first airflow passage 340 with vapor generated by heating the aerosol-generating article 10, and the generated aerosol may pass through the aerosol-generating article 10 and be released to the outside of the heater assembly 300.

The second airflow passage 340a may be formed inside the resonator 320 and may form a path that allows external air to flow into the resonator 320.

The second airflow passage 340a according to an example may be formed inside the first internal conductor 323 and may form a path that allows external air to flow into the aerosol-generating article 10 accommodated in the housing space 320h. For example, the second airflow passage 340a may be a flow path that connects an interior of the first internal conductor 323 to the aerosol-generating article 10 accommodated in the housing space 320h.

The second airflow passage 340a may be arranged such that external air moves in the longitudinal direction (e.g.: +z direction) of the housing space 320h and then flows into one end (for example, an end in the +z direction) of the aerosol-generating article 10 accommodated in the housing space 320h. In other words, the second airflow passage 340a may have one region extending in the longitudinal direction of the housing space 320h and another region formed to extend in a direction intersecting with the longitudinal direction of the housing space 320h and connect the one region of the second airflow passage 340a to the interior of the housing space 320h.

In this case, a closure 324 may include an air inlet hole 340c that passes through the closure 324 and is connected to the second airflow passage 340a. The air inlet hole 340c may be arranged in one region of the closure 324 and formed to extend in the longitudinal direction of the housing space 320h, and external air that has reached the closure 324 along the second airflow passage 340a may flow into the aerosol-generating article 10 accommodated in the housing space 320h through the air inlet hole 340c. In other words, because the closure 324 includes the air inlet hole 340c and closes a portion of a cross-section of the first internal conductor 323, a first end (e.g.: a first region of FIG. 8) of the first internal conductor 323, where the closure 324 is arranged, may be formed as a short end, without interfering with the flow of the external air toward the aerosol-generating article 10.

The second airflow passage 340a according to another example may be formed between the outer conductor 321 and the first and second internal conductors 323 and 325 and may form a path that allows external air to flow into the first internal conductor 323 or the second internal conductor 325. For example, the second airflow passage 340a may be a flow path that connects the dielectric material housing space 327 to the interior of the first internal conductor 323 or an interior of the second internal conductor 325.

The second airflow passage 340a may be arranged such that external air moves in a longitudinal direction (e.g.: −z direction) of the dielectric material housing space 327 and then flows into the first internal conductor 323 or the second internal conductor 325. In other words, the second airflow passage 340a may have one region extending in the longitudinal direction of the dielectric material housing space 327 and another region formed to extend in a direction intersecting with the longitudinal direction of the housing space 320h and connect the one region of the second airflow passage 340a to an interior of the dielectric material housing space 327.

In this case, the dielectric material D accommodated in the dielectric material housing space 327 may include an air inlet passage 3401 that passes through the dielectric material D and is connected to the second airflow passage 340a. The air inlet passage 3401 may be arranged in one region of the dielectric material D and formed to extend in the longitudinal direction of the dielectric material housing space 327, and external air that has reached the dielectric material housing space 327 along the second airflow passage 340a may flow into the resonator through the air inlet passage 3401.

In other words, the dielectric material D may adjust a dielectric constant of the resonator 320 without interfering with the flow of the external air into the resonator through the dielectric material housing space 327.

However, the second airflow passage 340a is not limited to the aforementioned embodiment, and any path through which external air may flow into the resonator 320 may correspond to the second airflow passage 340a without limitation. The second airflow passage 340a according to another example may be a flow path that connects the second airflow passage 340a according to the example described above to the second airflow passage 340a according to the other example described above. The second airflow passage 340a according to another example may be arranged such that external air moves in the longitudinal direction (e.g.: +z direction) of the housing space 320h and flows into one end (e.g.: an end in the +z direction) of the aerosol-generating article 10 accommodated in the housing space 320h, or may be arranged such that external air moves in the longitudinal direction (e.g.: −z-axis direction) of the dielectric material housing space 327, moves into the first internal conductor 323 or the second internal conductor 325, and then moves in the longitudinal direction (e.g.: +z direction) of the housing space 320h so as to flow into one end (e.g.: an end in the +z direction) of the aerosol-generating article 10 accommodated in the housing space 320h.

Because heat generated in the heater assembly 300 may be effectively released through the first airflow passage 340 or the second airflow passage 340a, external heat release of the heater assembly 300 may be minimized.

According to an example, the resonator 320 may further include a structure 341 (or “cap”) for supporting the aerosol-generating article 10 accommodated in the housing space 320h. The structure 341 may support at least one region of the aerosol-generating article 10 arranged inside the housing space 320h and accommodated in the housing space 320h.

For example, the structure 341 may be formed to have a hollow cylindrical shape having one end closed and the other end open, overall, and arranged to surround one region of the aerosol-generating article 10, thereby fixing a position of the aerosol-generating article 10 within the housing space 320h.

In addition, the structure 341 may prevent movement or diffusion of an aerosol generated from the aerosol-generating article 10 toward the first internal conductor 323 and/or the second internal conductor 325, thereby preventing formation of a droplet inside the resonator 320.

When the aerosol generated from the aerosol-generating article 10 reaches the first internal conductor 323 and/or the second internal conductor 325, a portion of the aerosol may liquefy, leading to formation of a droplet inside the first internal conductor 323 and/or the second internal conductor 325. The droplet formed in the first internal conductor 323 and/or the second internal conductor 325 may reduce heating efficiency of the resonator 320, but the heater assembly 300 according to another embodiment may prevent movement or diffusion of an aerosol toward the first internal conductor 323 and/or the second internal conductor 325 through the structure 341, thereby preventing a reduction in heating efficiency due to the droplet.

In this case, the structure 341 may include a material (e.g.: polytetrafluoroethylene material) with excellent heat resistance and/or excellent chemical resistance to prevent damage caused by an aerosol or droplet generated inside the housing space 320h.

According to an embodiment, the structure 341 may include an air inlet hole that passes through the structure 341 and is connected to the first airflow passage 340 and/or the second airflow passage 340a. The air inlet hole may be formed in the closed end of the structure 341, and external air that has reached the structure 341 along the first airflow passage 340 and/or the second airflow passage 340a may flow into the aerosol-generating article 10 supported by the structure 341 through the air inlet hole. In other words, by including the air inlet hole, the structure 341 may support the aerosol-generating article 10 without interfering with the flow of the external air toward the aerosol-generating article 10.

The heater assembly 300 according to another embodiment may include a heat dissipation member (e.g.: the heat dissipation member of FIG. 5). The heat dissipation member may be arranged inside the resonator 320 and may take heat away from the inside of the resonator 320 and release the heat to a region surrounding the heat dissipation member. For example, the heat dissipation member may be arranged inside the first internal conductor 323 and may act as a heat sink for heat released from the inside of the resonator 320 to the outside of the resonator 320, and the heat dissipation member may release the absorbed heat toward a medium (e.g.: the aerosol-generating article 10) with a relatively low temperature. In other words, the heat dissipation member may improve the overall thermal insulation performance of the resonator 320.

The heat dissipation member may include a hole that passes through the heat dissipation member and is connected to the second airflow passage 340a. The hole in the heat dissipation member may be arranged in one region of the heat dissipation member and may be formed to extend in the longitudinal direction (e.g.: +z-axis direction) of the housing space 320h and/or a direction (e.g.: +x-axis direction) intersecting with the longitudinal direction of the housing space 320h. In this case, the heat dissipation member may be connected to the first airflow passage 340 through the hole formed to extend in the longitudinal direction (e.g.: +z-axis direction) of the housing space 320h. Accordingly, external air that has reached the heat dissipation member along the second airflow passage 340a may flow into the aerosol-generating article 10 accommodated in the housing space 320h through the hole in the heat dissipation member. In other words, because the heat dissipation member includes the hole having the aforementioned structure, the overall thermal insulation performance of the resonator 320 may be improved.

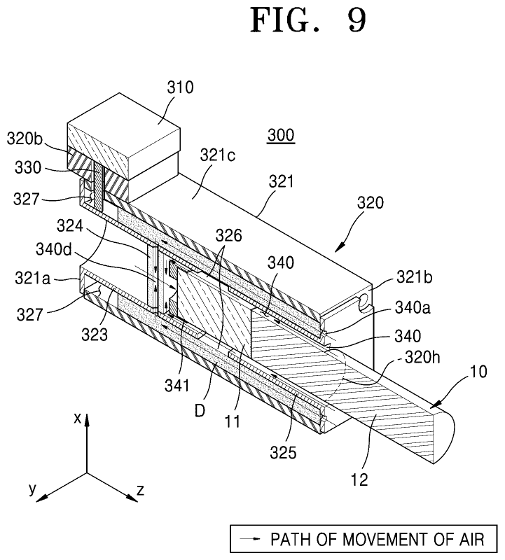

Hereinafter, an air inlet hole 340d in the closure 324, which is different from the air inlet hole 340c in the closure 324 described above, is described with reference to FIG. 9.

FIG. 9 is a cross-sectional view of another example of the heater assembly of FIG. 7. FIG. 9 shows a cross-section of the heater assembly 300 of FIG. 7 cut in the B-B′ direction, and arrows in FIG. 9 indicate paths of movement of air (or “external air”).

Referring to FIG. 9, the heater assembly 300 of FIG. 9 may include the oscillator 310, the resonator 320, the first airflow passage 340, the second airflow passage 340a, and the closure 324, the heater assembly 300 of FIG. 9 may differ from the heater assembly 300 of FIG. 8 only in the arrangement of the air inlet hole in the closure 324, and hereinafter, redundant descriptions are omitted.

The second airflow passage 340a may be formed inside the resonator 320 and may form a path that allows external air to flow into the resonator 320.

The second airflow passage 340a may be arranged such that external air moves in the longitudinal direction (e.g.: −z direction) of the dielectric material housing space 327 and then flows into the first internal conductor 323 or the second internal conductor 325. In other words, the second airflow passage 340a may have one region extending in the longitudinal direction of the dielectric material housing space 327 and another region formed to extend in a direction intersecting with the longitudinal direction of the housing space 320h and connect the one region of the second airflow passage 340a to the interior of the dielectric material housing space 327.

The resonator 320 may include the closure 324 that is arranged inside the first internal conductor 323 and closes a cross-section of the first internal conductor 323 to limit a flow direction of an aerosol generated from the aerosol-generating article 10. For example, the closure 224 may close a cross-section of the first internal conductor 223 to block flow of an aerosol, which is generated from the aerosol-generating article 10, in the −z direction.

When the aerosol generated from the aerosol-generating article 10 or a droplet formed by liquefaction the aerosol flows in the −z direction into another constituting element of the aerosol-generating device (e.g.: the aerosol-generating device 100 of FIG. 1), the constituting elements of the aerosol-generating device may malfunction or be damaged. In contrast, the heater assembly 300 according to an embodiment may prevent malfunction of or damage to the constituting elements of the aerosol-generating device due to an aerosol or a droplet, by limiting a flow direction of the aerosol through the closure 324.

The closure 324 may further include the air inlet hole 340d that passes through the closure 324 and is connected to the second airflow passage 340a. The air inlet hole 340d may be arranged in one region of the closure 324 and formed to extend in a direction (e.g.: +x-axis direction) intersecting with the longitudinal direction of the housing space 320h, and external air that has reached the closure 324 along the second airflow passage 340a may flow into the air inlet hole 340d and the aerosol-generating article 10 accommodated in the housing space 320h through the air inlet hole 340c. In other words, because the closure 324 further includes the air inlet hole 340d and closes a portion of a cross-section of the first internal conductor 323, malfunction of or damage to the constituting elements of the aerosol-generating device due to an aerosol or a droplet may be prevented, without interfering with the flow of the external air toward the aerosol-generating article 10.

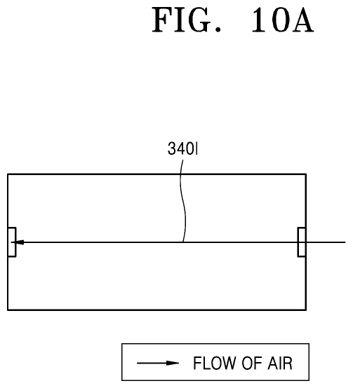

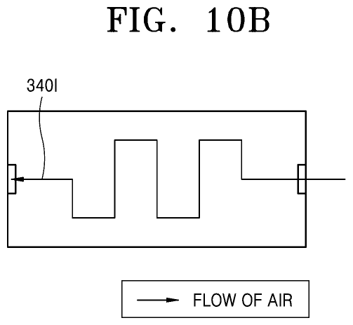

Hereinafter, the arrangement of the air inlet passage 3401 that passes through the dielectric material D accommodated in the dielectric material housing space 327 and is connected to the second airflow passage 340a is described in detail with reference to FIGS. 10A and 10B.

FIG. 10A is a diagram showing an example of the air inlet passage 3401 of the heater assembly of FIG. 7, and FIG. 10B is a diagram showing another example of an airflow passage of the heater assembly of FIG. 7. FIGS. 10A and 10B show a cross-section of the heater assembly 300 of FIG. 7 cut in a C-C′ direction, and arrows in FIGS. 10A and 10B indicate paths of movement of air (or “external air”).

Referring to FIGS. 10A and 10B, the dielectric material D accommodated in the dielectric material housing space 327 may include the air inlet passage 3401 that passes through the dielectric material D and is connected to the second airflow passage 340a.

The air inlet passage 3401 may be arranged in one region of the dielectric material D accommodated in the dielectric material housing space (e.g.: the dielectric material housing space 327 of FIGS. 7 to 9) and may be formed to extend in the longitudinal direction of the dielectric material housing space or a direction intersecting with the longitudinal direction of the dielectric material housing space, and external air that has reached the dielectric material housing space 327 along the second airflow passage 340a may flow into the resonator through the air inlet passage 3401.

The air inlet passage 3401 may be arranged in one region of the dielectric material D accommodated in the dielectric material housing space and may be bent a plurality of times in a direction parallel or perpendicular to, or at an angle to the longitudinal direction of the dielectric material housing space.

For example, the air inlet passage 3401 may be bent in a direction perpendicular to the longitudinal direction of the dielectric material housing space and then bent at an angle to the longitudinal direction of the dielectric material housing space. As another example, the air inlet passage 3401 may be bent three times in total in a direction perpendicular to the longitudinal direction of the dielectric material housing space, bent twice in total at an angle to the longitudinal direction of the dielectric material housing space, and bent four times in total at a different angle to the longitudinal direction of the dielectric material housing space. However, the present disclosure is not limited thereto, and depending on embodiments, the shape of the air inlet passage 3401 may vary. As another example, the air inlet passage 3401 may have an irregular shape.

As the air inlet passage 3401 is formed to have a more complex shape, heat generated from the resonator may be more efficiently released to the outside of the resonator during a process where external air flows into the resonator (e.g.: the resonators 220 and 320 of FIGS. 1 to 9) along the air inlet passage 3401, and thus, external heat release of the heater assembly 300 may be minimized.

Any of the embodiments or other embodiments of the present disclosure described above are not mutually exclusive or distinct. Any of the embodiments or other embodiments of the present disclosure described above may be combined or combined in their respective configurations or functions.

For example, it means that the A configuration described in a specific embodiment and/or the drawings and the B configuration described in another embodiment and/or the drawings may be combined. That is, even if the combination between the configurations is not directly described, it means that the combination is possible, except in cases where the combination is described as impossible.

The above detailed description should not be construed as limiting in all respects, but should be considered as illustrative. The scope of the present disclosure should be determined by a reasonable interpretation of the appended claims, and all changes within the equivalent scope of the present disclosure are included in the scope of the present disclosure.

1. A heater assembly comprising:
an oscillator that generates microwaves in a designated frequency band; and
a resonator that receives the generated microwaves from the oscillator through a coupler and generates an electric field by resonating the received microwaves,
wherein the resonator comprises:
an outer conductor comprising a first surface, a second surface facing the first surface, and a side surface surrounding an internal space between the first surface and the second surface, and comprising a housing space for accommodating an aerosol-generating article;
a first internal conductor extending from the first surface toward the internal space and surrounding one region of the aerosol-generating article accommodated in the housing space;
a first airflow passage connecting an exterior of the resonator to the housing space; and
a second airflow passage connecting the exterior of the resonator to an interior of the resonator.

2. The heater assembly of claim 1, wherein
the first airflow passage is arranged such that external air moves in a longitudinal direction of the housing space and then flows into one end of the aerosol-generating article inserted into the housing space.

3. The heater assembly of claim 1, wherein
the second airflow passage is arranged such that external air moves into the first internal conductor and then flows into one end of the aerosol-generating article inserted into the housing space.

4. The heater assembly of claim 1, wherein
the second airflow passage is arranged such that external air flows between the outer conductor and the first internal conductor.

5. The heater assembly of claim 1, wherein
the second airflow passage is arranged such that external air flows between the outer conductor and the first internal conductor, moves into the first internal conductor, and then flows into one end of the aerosol-generating article inserted into the housing space.

6. The heater assembly of claim 1, wherein
the resonator further comprises:
a dielectric material housing space formed between the outer conductor and the first internal conductor; and
a dielectric material arranged in the dielectric material housing space, and
the second airflow passage is arranged such that external air moves into the dielectric material housing space and then flows into one end of the aerosol-generating article accommodated in the housing space.

7. The heater assembly of claim 6, wherein
the dielectric material comprises an air inlet passage that passes through the dielectric material and is connected to the second airflow passage, and
the external air moves along the air inlet passage and flows into the resonator.

8. The heater assembly of claim 7, wherein
the air inlet passage is formed to have a shape that is bent a plurality of times in a direction parallel or perpendicular to, or at an angle to a longitudinal direction of the dielectric material housing space.

9. The heater assembly of claim 1, wherein
the resonator further comprises
a heat dissipation member that is arranged inside the first internal conductor and absorbs heat inside the resonator.

10. The heater assembly of claim 1, wherein
the resonator further comprises
a second internal conductor extending from the second surface toward the internal space and surrounding another region of the accommodated aerosol-generating article.

11. The heater assembly of claim 10, wherein
the first internal conductor is arranged to surround the one region of the aerosol-generating article inserted into the housing space,
the second internal conductor is spaced apart from the first internal conductor by a certain distance in the internal space and arranged to surround the other region of the aerosol-generating article accommodated in the housing space, and
the resonator further comprises a closure that is arranged inside the first internal conductor and closes a cross-section of the first internal conductor.

12. The heater assembly of claim 11, wherein
the closure comprises an air inlet hole that passes through the closure and is connected to the first airflow passage or the second airflow passage, and
external air that moves along the first airflow passage or the second airflow
passage flows into one end of the aerosol-generating article through the air inlet hole.

13. An aerosol-generating device comprising:
a housing comprising an insertion hole into which an aerosol-generating article is inserted; and
a heater assembly for heating the aerosol-generating article inserted through the insertion hole,
wherein the heater assembly comprises:
an oscillator that generates microwaves in a designated frequency band; and
a resonator that receives the generated microwaves from the oscillator through a coupler and generates an electric field by resonating the received microwaves, and
the resonator comprises:
an outer conductor comprising a first surface, a second surface facing the first surface, and a side surface surrounding an internal space between the first surface and the second surface, and comprising a housing space for accommodating the aerosol-generating article;
a first internal conductor extending from the first surface toward the internal space and surrounding one region of the aerosol-generating article accommodated in the housing space;
a first airflow passage connecting an exterior of the resonator to the housing space; and
a second airflow passage connecting the exterior of the resonator to an interior of the resonator.

14. The heater assembly of claim 13, wherein
the second airflow passage is arranged such that external air moves into the first internal conductor and then flows into one end of the aerosol-generating article inserted into the housing space.

15. The heater assembly of claim 13, wherein
the resonator further comprises
a second internal conductor extending from the second surface toward the internal space and surrounding another region of the accommodated aerosol-generating article.
